(19) United States
(12) Patent Application Publication
(10) Pub. No.: US 2007/0146643 A1
(43) Pub. Date: Jun. 28, 2007

(54) Vertically oriented segmented display system

(76) Inventors: Mark Alan Schultz, Carmel, IN (US); Matthew Robert Lamb, Westfield, IN (US); Youngshik Yoon, Indianapolis, IN (US); Charles Bryan Hunt, Westfield, IN (US); Billy Wesley Beyers, Carmel, IN (US); Michael Scott Deiss, Zionsville, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/583,799

(22) PCT Filed: Dec. 22, 2004
(86) PCT No.: PCT/US04/43375

§ 371 Date: Jun. 21, 2006

Related U.S. Application Data
(60) Provisional application No. 60/531,747, filed on Dec. 22, 2003.

(51) Int. Cl. G03B 21/26

(52) U.S. Cl. 353/34

(57) ABSTRACT

A segmented display system in which the display devices are arranged in a N×1 array is described. The segmented display system includes a plurality of projection devices that each project a portion of an image on a corresponding one of the display devices in the N×1 array. Distortion at the seams between display devices in the N×1 array are minimized by aligning each projection device using a lens mounting based on the position of such projection device in the N×1 array.

### CROSS-REFERENCE TO RELATED APPLICATIONS

This application claims the benefit of U.S. Provisional Patent Application Ser. No. 60/531,747, entitled “Biased Lens Mounting for Segmented Displays” and filed Dec. 22, 2003, which is incorporated by reference herein in its entirety.

### FIELD OF THE INVENTION

The present invention generally relates to the field of displays, and more particularly to segmented display systems including multiple projection devices.

### BACKGROUND OF THE INVENTION

Segmented display systems generally employ multiple projection devices and multiple display devices. Each projection device projects a portion of an image on a corresponding one of the display devices. For many segmented display systems, the display devices are arranged in a square array (N×N), such as, for example, a 2×2 array, as shown in FIG. 1.

However, arranging the display devices in a square array provides a four quadrant seam 20. The four quadrant seam 20 is undesirably distorts the images displayed on the segmented display system.

Thus, there is a need for a segmented display system which minimizes distortion of the displayed images.

### SUMMARY OF THE INVENTION

The present invention is directed to a segmented display system in which the display devices are arranged in a N×1 array. The segmented display system includes a plurality of projection devices that each project a portion of an image on a corresponding one of the display devices in the N×1 array. Distortion at the seams between display devices in the N×1 array are minimized by aligning each projection device using a lens mounting based on the position of such projection device in the N×1 array.

### BRIEF DESCRIPTION OF THE DRAWINGS

The invention is hereinafter described in detail with reference to the accompanying drawings, in which:

FIG. 1 depicts a segmented display system in which display devices are arranged in a 2×2 array;

FIG. 2 depicts a front view of a segmented display system of the present invention in which display devices are arranged in a N×1 array;

FIG. 3 depicts a top view of the segmented display system shown in FIG. 2 in which display devices are arranged in the N×1 array;

FIG. 4 depicts a side view of the segmented display system shown in FIG. 2 in which display devices are arranged in the N×1 array;

FIG. 5 depicts distortion at the seams between display devices in the N×1 array using identical lens mountings for each projection device; and

FIG. 6 depicts distortion at the seams between display devices in the N×1 array by aligning each projection device using a lens mounting based on the position of such projection device in the N×1 array.

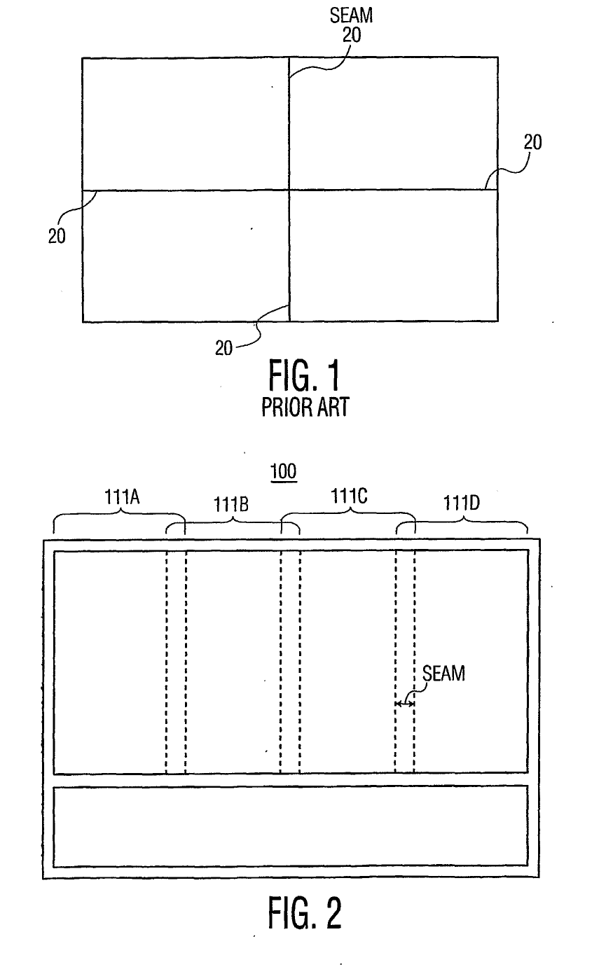

### DETAILED DESCRIPTION

The present invention is directed to a segmented display system in which the display devices are arranged in a N×1 array. Referring the FIGS. 2-4, the segmented display system 100 includes a plurality of projection devices 110A, 110B, 110C, 110D that each project a portion of an image on a corresponding one of the display devices 111A, 111B, 111C, 111D in the N×1 array.

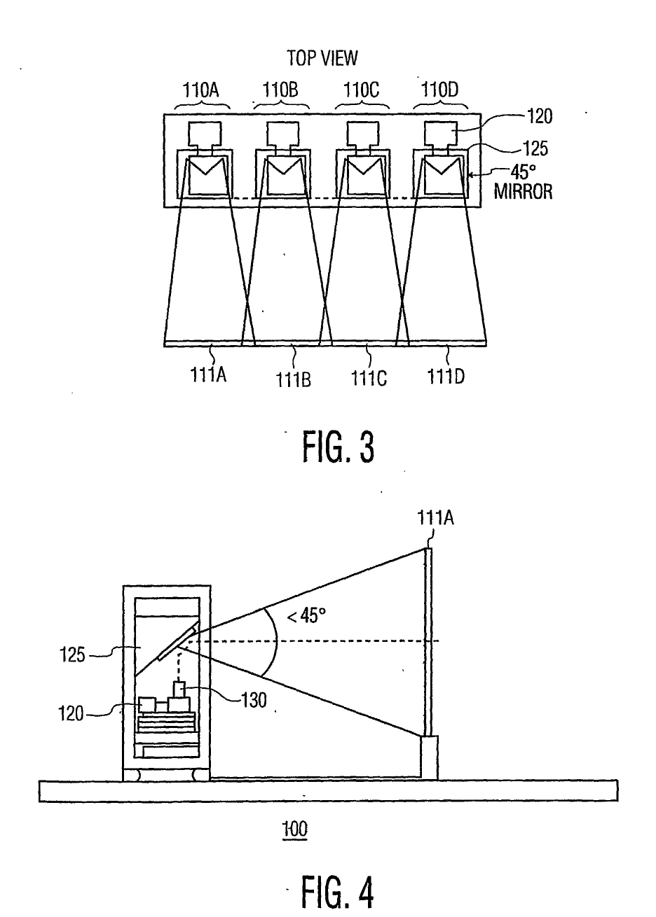

Referring to FIG. 4, each projection device 110A, 110B, 110C, 110D includes a lamp 120, a mirror 125 and a lens mounting 130. The lamp 120 of each projector projects that portion of the image to be projected onto the mirror 125 and than to the corresponding one of the display devices 111A, 111B, 111C, 111D in the N×1 array.

The mirror 125 is placed at an angle of about 45 degrees relative to the lamp 120 and the display devices 111A, 111B, 111C, 111D. Using a mirror at about 45 degrees with respect to the lamp 120 maintains bulb lifetime due to thermal heating in the lamp 120.

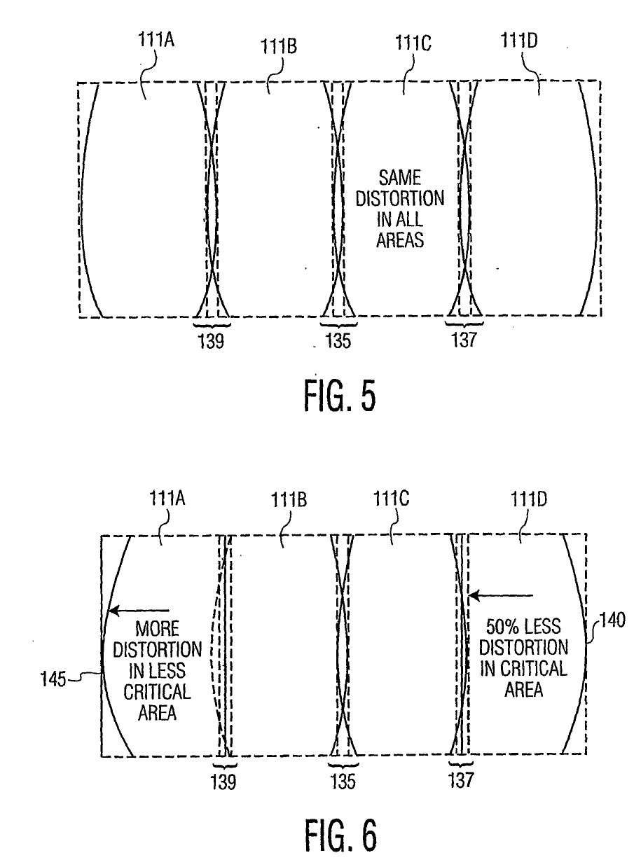

Distortion at the seams 135, 137, 139 between display devices in the N×1 array are minimized by aligning each projection device using a lens mounting 130 based on the position of such projection device in the N×1 array. More specifically, FIG. 5 depicts distortion at the seams between display devices in a 4×1 array using identical lens mountings for each projection device. For the 4×1 array there are three seams. Using identical lens mountings for each seam provides a segmented display system with the same amount of distortion along each seam.

FIG. 6 depicts distortion at the seams between display devices in the 4×1 array by aligning each projection device using a lens mounting based on the position of such projection device in the N×1 array. More specifically, the two center projectors 110B, 110C use lens mountings 130A that provide symmetrical distortion on both sides along the center seam 135.

Projection device 110D uses a lens mounting 130B that provides a straight edge at seam 137 and distortion along edge 140. It is important to provide the straight edge at seam 137 to reduce distortion effects of the projected image. The distortion along edge 140 is less noticeable and thus less critical at the edges of the image.

Projection device 110A uses a lens mounting 130A that provides a straight edge at seam 139 and distortion along edge 145. It is important to provide the straight edge at seam 139 to reduce distortion effects of the projected image. The distortion along edge 145 is less noticeable and thus less critical at the edges of the image.

The result shown in FIG. 6 is that the middle seam 135 is unchanged but the two side seams 135, 137 have about 50% of the original distortion. The left and right edges that remain distorted are noticeable.

What is claimed is:

1. A projection system, comprising:
a plurality of displays arranged adjacent to each other to form a screen, wherein a portion of adjacent displays overlap one another to form a seam;
a plurality of projectors, one corresponding to each display of the plurality of displays, wherein each projector includes a lens selected to reduce distortions at the seams formed between adjacent displays.

2. The projection system of claim 1 wherein the plurality of displays are arranged in an N×1 array.

3. The projection system of claim 1 wherein each of the plurality of projectors further includes a mirror.

4. The projection system of claim 3 wherein the mirror is aligned at an angle of about 45 degrees with respect to a lamp of the projector.
